(19) United States
(12) Patent Application Publication
(10) Pub. No.: US 2014/0144006 A1
(43) Pub. Date: May 29, 2014

(54) LADDER RING CAGE

(71) Applicant: BRAND SERVICES LLC, Kennesaw, GA (US)

(72) Inventor: Mike Ashouri, Sugar Land, TX (US)

(73) Assignee: Brand Services LLC, Kennesaw, GA (US)

(21) Appl. No.: 13/684,878

(22) Filed: Nov. 26, 2012

(51) Int. Cl. E06C 7/50; E06C 7/18

(52) U.S. Cl. CPC E06C 7/50; E06C 7/185
USPC 29/525.08; 182/106

(57) ABSTRACT

A ladder cage comprises a plurality of spaced rings, having fasteners attached thereto. A plurality of vertical braces are each attached to respective ones of the fasteners, the vertical braces each having a mounting hole proximate each end, and extending between two of the plurality of rings. Each of the fasteners comprises a mounting pin having a slot therein, and a drop pin slidably mounted to that fastener for sliding in and out of its slot. An associated vertical brace is fastened to a ring by each fastener, as the fastener's mounting pin is received in the mounting hole of the associated vertical brace, and the drop pin of the fastener is received in the slot of said mounting pin, such that the drop-pin makes an angle of between about 30° and 60° to the vertical.

### FIELD OF THE INVENTION

The present invention relates generally to building equipment, and more particularly to ladder cages for use with scaffolding and other structures.

### BACKGROUND

Tall structures such as communications towers, wind turbines, scaffolding, and the like are often equipped with a ladder that may be climbed to reach points of elevation on the structure, for service or the like. Often, such ladders provide the only easy access to these points of elevation. As well, the ladders typically extend completely vertically, to significant heights and present a risk to a climber.

As such, these ladders are often surrounded by generally semi-circular rings, affixed at either side of the ladder typically along the extent of the ladder, Vertical bars extend between the rings. The rings and bars define a ladder cage, and provide security for the climber to inhibit a downward or outward fall away from the ladder.

Typically, these rings are securely affixed to the ladder, and as such are not easy to install and cannot be easily moved or removed. For some structures, however, easy removal and installation are desirable.

As such, there remains a need for a ladder cage assembly that may be easily installed and removed.

### SUMMARY

In accordance with an aspect of the present invention, there is provided a ladder cage comprising: a plurality of spaced rings, having fasteners attached thereto; a plurality of vertical braces, each having a mounting hole proximate each end, and extending between two of the plurality of rings, and attached at either end to respective ones of the fasteners; wherein each of the fasteners comprises a mounting pin having a slot therein, and a drop pin slidably mounted to that fastener for sliding in and out of its slot in its mounting pin; and wherein an associated vertical brace is fastened to a ring by that fastener, as its mounting pin is received in the mounting hole of the associated vertical brace, and the drop pin of the fastener is received in the slot of said mounting pin, wherein the drop-pin makes an angle of between about 30° and 60° to the vertical.

In accordance with another aspect of the present invention, there is provided a ring for forming a ladder cage comprising: a ring shaped body having fasteners attached thereto; each of the fasteners comprising a mounting pin having a slot therein, and a drop pin slidably mounted to that fastener for sliding in and out of its slot in its mounting pin, wherein the drop pin is mounted so it may make an angle of between 30° and 60° to the vertical; and wherein an associated vertical brace may be fastened to the ring by that fastener, as its mounting pin is received in the mounting hole of the associated vertical brace, and the drop pin of the fastener is received in the slot of the mounting pin.

In accordance with yet another aspect of the present invention, there is provided a method of assembling a ladder cage comprising: attaching two spaced rings having fasteners attached thereto to a ladder; each of the fasteners comprising a mounting pin having a slot therein, and a drop pin slidably mounted to that fastener for sliding in and out of its slot in its mounting pin, wherein the drop pin is mounted at an angle of between about 30° and 60° to a plane of its ring; attaching a vertical brace to the two spaced rings by inserting a mounting pin of corresponding ones of the fasteners on each of the two spaced rings into a hole of the vertical brace; and sliding a drop pin mounted to each of the corresponding one of the fasteners to rest at an angle of between 30° and 60° to the vertical into a slot in their mounting pins to fasten the vertical brace to the ring by the fastener on each of the two spaced rings.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a perspective view of a ladder and ladder cage, exemplary of an embodiment of the present invention;

FIG. 2 is a perspective view of a brace of the ladder cage of FIG. 1;

FIG. 3 is a perspective view of a ladder cage ring of the ladder brace of FIG. 1; and

FIG. 4 is a perspective view of a fastener of the ladder cage of FIG. 1.

### DETAILED DESCRIPTION

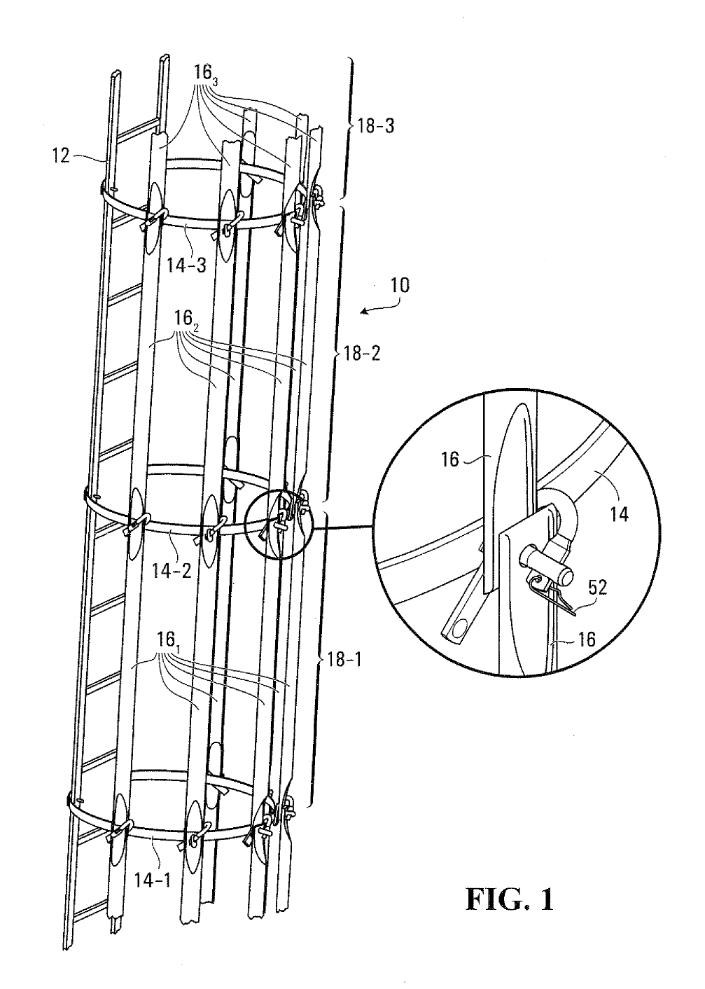

FIG. 1 is a perspective view of ladder cage 10, exemplary of an embodiment of the present invention. Ladder cage 10 provides support/safety to a climber of ladder 12. Ladder 12 may be part of a free standing structure (otherwise not shown), such as a building scaffold, a wind turbine tower, a communications tower, or the like. As illustrated, ladder cage 10, when assembled forms a generally cylindrical cage that encircles a climber of ladder 12. Ladder cage 10 is affixed around ladder 12, to provide protection to a climber in case of a backward/outward fall.

Cage 10 includes several rings 14-1, 14-2, 14-3, . . . 14-n (individually and collectively rings 14—only three are illustrated in FIG. 1), and vertical braces 16 extending between rings 14 in the direction of extent of ladder 12. Ladder cage 10 may be formed in several sections 18-1, 18-2, 18-3, . . . 18-n (individually and collectively sections 18)—with each section defined by two adjacent rings 14 and the vertical braces 16 between them. Sections 18 may extend continuously along the length of ladder 12, or discontinuously, with sections separated by a space. Rings 14 are spaced along the extent of ladder 12, typically, but not necessarily, at equal distances from one another.

Vertical braces 16 are typically identical, having like dimensions. For convenience, vertical braces 16 in a section 18—i.e. between the same two rings 14—are identified with a common subscript in FIG. 1. Thus, in FIG. 1, vertical braces 16₁ all interconnect rings 14-1 and 14-2 in section 18-1; vertical braces 16₂ all interconnect rings 14-2 and 14-3 in section 18-2; vertical braces 16₃ all interconnect rings 14-3 and 14-4 in section 18-3; and so on.

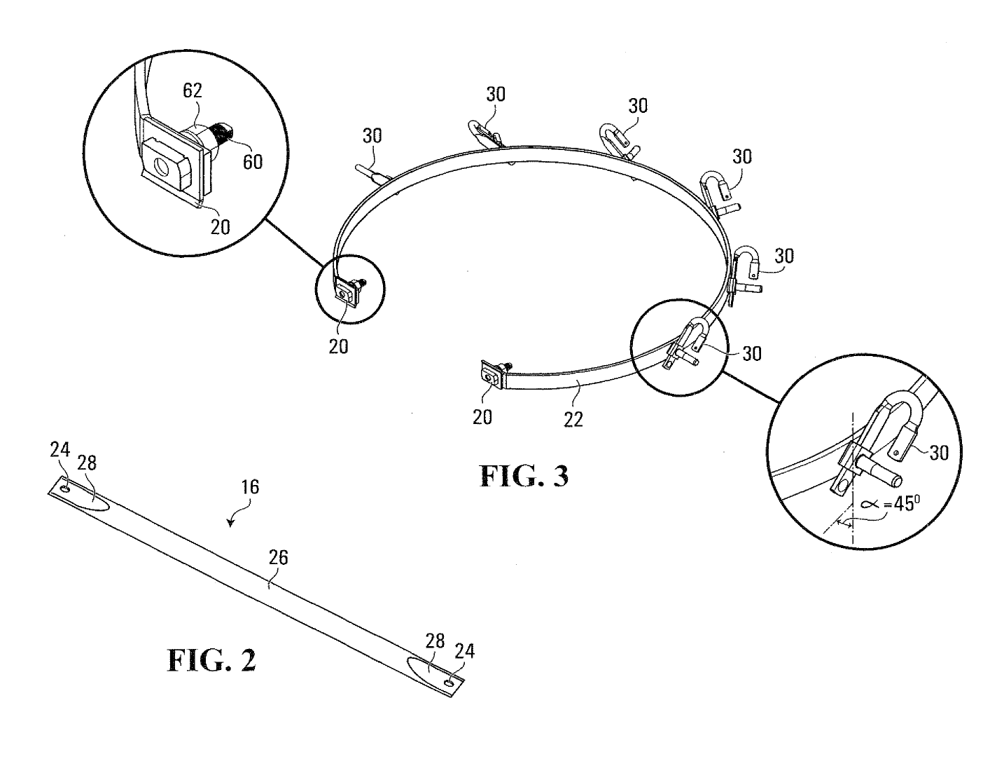

As illustrated in FIG. 2, each vertical brace 16 may take the form of a standard scaffold brace, formed of steel or aluminium, having a flattened ends 28, extending from a generally cylindrical body portion 26. Each flattened end 28 may further include a hole 24 for mounting brace 16 on a corresponding mounting pin. The mounting pin may take the form of a pin, a bolt, a post, a shaft, or any other suitable protrusion.

As more particularly illustrated in FIG. 3, each ring 14 includes an arc shaped metal or alloy band 22, having several fasteners 30 extending outwardly therefrom, and evenly spaced along band 22. Band 22 may be formed of the same material as brace 16—i.e. steel, aluminium, or the like.

Each fastener 30 serves to secure one or two vertical braces 16 to a ring 14. For a ring 14 shared by two sections 18 of cage 10, a single fastener 30 receives an upwardly extending vertical brace 16, and a downwardly extending brace 16, as best illustrated by the enlarged portion of FIG. 1. The end of band 22 may be folded inwardly, and further include bolt and nut 60, 62 or similar fastener for bolting ring 14 to ladder 12. The arc formed by band 22 is sized so that its inwardly folded ends of band 22 attach to vertically extending struts of ladder 12, at equal vertical positions along ladder 12, thus leveling the plane of ring 14 horizontally. Of course, as will be appreciated, ring 14 need not be formed of a flat band, but could instead be formed with a tubular cross-section tube, or having any other suitable cross-sectional geometry. Likewise, rings 14 need not be formed in circular arc shapes. For example, rings 14 may instead be rectangular, elliptical or formed in any other simple or complex shapes suitable for a given application. In the depicted embodiment, the distance between folded ends of band 22 is about 60 cm, the length of each brace 16 is about 1 m, and braces 16 are circumferentially spaced by about 20 cm around ring 14.

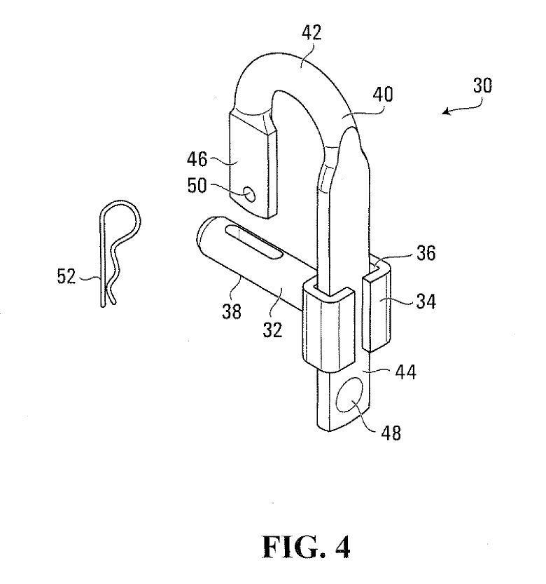

An example fastener 30 for fastening brace 16 to ring 14 is more particularly illustrated in FIG. 4. As illustrated, fastener 30 includes a mounting pin 32 mounted on a base 34, and a U-shaped drop-pin 40. Base 34 may be attached to ring 14, and includes a slot 36. Slot 36 is in a plane tangent to ring 14. Mounting pin 32 includes a further slot 38, in plane normal to that of slot 36. U-shaped drop pin 40 has a curved top 42 and two flat arms 44 and 46 and is slidably received within slot 36. Flat arms 44 and 46 are also oriented in planes normal to each other, so that arm 44 may be received in slot 36, and slide freely therein, while arm 46 may be slid in, out of, and through slot 38. A nib 48 on arm 44 stops arm 44 from being completely slid through slot 36, thus preventing U-shaped drop pin 40 from being separated from base 34. Alternatively, or additionally, arm 44 may include a hole for receiving a cotter pin or the like for preventing drop pin 40 from being separated from base 34. Optionally, arm 46 may include a hole 50 on arm 46 for receiving a cotter-pin 52 or the like, to lock U-shaped drop pin 40 in place (as shown in FIG. 1). Slots 36 and 38 and arms 44 and 46 are depicted as flat, but could take any suitable complementary shapes. For example, slots 36, 38 and arms 44 and 46 could be round in cross-section, semi-circular in cross-section, or any other suitable shape.

As further illustrated in FIG. 1, U-shaped drop pin 40 is used to lock a flattened end 28 of brace 16 in place on mounting pin 32. Conveniently, U-shaped drop pin 40 is pulled out of base 34 to open fastener 30, and allow hole 24 of brace 16 to slide on and off of pin 32, past slot 38. U-shaped drop pin 40 may be sized and oriented so that, when drop pin 40 is pulled out of base 34 as far as nib 38 permits, sufficient horizontal space is provided between pin 32 and arm 46 so that arm 46 clears the vertical edges of end portion 28 of brace 16, as hole 24 is slid onto pin 32. After hole 24 is slid onto pin 32, drop pin 40 may be slid into slot 38 to close fastener 30, and optionally locked by pinning cotter-pin 52 into hole 50. Drop pin 40 may also be sized and oriented to provide sufficient horizontal space between pin 32 and the inside of curved top 42 so that, once hole 24 is slid onto pin 32 drop pin 40 may be closed with arm 46 fully in slot 38 before the inside of curved top 32 contacts the vertical edges of end portion 28. Of course, in order for fastener 30 to be able to accept both upwardly and downwardly-extending braces 16 with vertical end portions 28, drop pin 40 should be at an angle to the vertical that will depend on the geometry of fastener 30 and end portions 28.

Fastener 30 is mounted to ring 14, so that U-shaped drop pin 40 slides at an angle of about α=45° to the vertical (i.e. at an angle α to the plane of ring 14). In this way, U-shaped drop pin 40 is naturally pulled by gravity into slot 36. Once drop pin 40 is slid into slot 38, it locks one or more braces 16 into place on pin 32, preventing brace 16 from sliding off pin 32. Likewise, the size and angled orientation of U-shaped drop-pin 40, provides clearance for both an upwardly and downwardly extending brace 16 to be received on pin 32. As will now be appreciated, mount angles of less than or more than 45° may achieve the same effect. The mount angle may be any angle which provides sufficient clearance for braces 16, given the geometry of drop pin 40, and that result in a sufficient downward pull of drop pin 40 into slot 36 by gravity. For example, angles of between 30° and 60° may be appropriate.

Conveniently, ring 14 with fasteners 30 allow for relatively quick assembly of ladder cage 10. Two adjacent rings 14 may be attached to ladder 12, and braces 16 may be attached to these rings 14. U-shaped drop pins 40 may be quickly and readily slid between the open and closed position of fastener 30, to allow for easy installation of braces 16. At the same time, the effect of gravity biases U-shaped drop-pins 40 closed. With the aid of gravity, use of cotter-pins 52 is optional.

Ladder cage 10 may similarly be disassembled, to allow easy removal, by sliding U-shaped drop pins 40 upward, providing clearance to allow the flattened ends 28 of braces 16 to be slid outward, off of pins 32. Once braces 16 are removed from rings 14, rings 14 may be removed from ladder 10.

As will be appreciated U-shaped drop pins 40 could be replaced with drop pins of another shape—for example linear drop pins could be used.

pun In an alternate embodiment, fastener 30 (and hence drop pin 40) could be mounted to ring 14 so that it may be rotatable or pivotal about an axis of pin 32. The drop pin 40 could be rotated to an arbitrary angular position as braces 16 are installed. For example, to suit a particular application or the preference of an installer, fastener 30 could be rotated so that drop pin 40 is in a substantially horizontal orientation, parallel to the plane of ring 14, as the braces 16 are installed. Thereafter, the pin could be rotated to make a suitable angle with the vertical to lock drop pin 40 with the aid of gravity after brace(s) 16 is/are installed

Of course, the above described embodiments, are intended to be illustrative only and in no way limiting. The described embodiments of carrying out the invention, are susceptible to many modifications of form, arrangement of parts, details and order of operation. The invention, rather, is intended to encompass all such modification within its scope, as defined by the claims.

What is claimed is:

1. A ladder cage comprising:
a plurality of spaced rings, having fasteners attached thereto;
a plurality of vertical braces, each having a mounting hole proximate each end, and extending between two of said plurality of rings, and attached at either end to respective ones of said fasteners;
wherein each of said fasteners comprises a mounting pin having a slot therein, and a drop pin slidably mounted to that fastener for sliding in and out of its slot in its mounting pin; and
wherein an associated vertical brace is fastened to a ring by that fastener, as its mounting pin is received in the mounting hole of the associated vertical brace, and the drop pin of the fastener is received in the slot of said mounting pin, wherein the drop-pin makes an angle of between about 30° and 60° to the vertical.

2. The ladder cage of claim 1, wherein said drop-pin of each of said fasteners is U-shaped.

3. The ladder cage of claim 1, wherein said drop-pin of each of said fasteners is mounted at an angle of about 45° to the vertical

4. The ladder cage of claim 2, wherein said drop-pin of each of said fasteners comprises a first flat end to be received in the slot of its mounting pin.

5. The ladder cage of claim 3, wherein said fastener further comprises a further slot to receive a second end of said drop-pin.

6. The ladder cage of claim 4, wherein said second end comprises a nib, to prevent said second end from being removed from said further slot.

7. The ladder cage of claim 5, wherein said slot of said mounting pin and said further slot lie in perpendicular planes.

8. The ladder cage of claim 1, wherein said mounting pin is sized to receive the ends of upwardly and downwardly extending vertical braces.

9. The ladder cage of claim 1, wherein said ring and vertical braces are formed of at least one of aluminum and steel.

10. The ladder cage of claim 1, wherein said fasteners are equally spaced around said rings.

11. The ladder cage of claim 1, further comprising a cotter-pin to lock each of said fasteners into place.

12. The ladder cage of claim 1, wherein said each of said fasteners is mounted to rotate about its mounting pin.

13. A ring for forming a ladder cage comprising:
a ring shaped body having fasteners attached thereto;
each of said fasteners comprising a mounting pin having a slot therein, and a drop pin slidably mounted to that fastener for sliding in and out of its slot in its mounting pin, wherein the drop pin is mounted so it may make an angle of between 30° and 60° to the vertical;
and wherein an associated vertical brace may be fastened to said ring by that fastener, as its mounting pin is received in the mounting hole of the associated vertical brace, and the drop pin of the fastener is received in the slot of said mounting pin.

14. A method of assembling a ladder cage comprising:
attaching two spaced rings having fasteners attached thereto to a ladder;
each of said fasteners comprising a mounting pin having a slot therein, and a drop pin slidably mounted to that fastener for sliding in and out of its slot in its mounting pin, wherein the drop pin is mounted at an angle of between about 30° and 60° to a plane of its ring;
attaching a vertical brace to said two spaced rings by inserting a mounting pin of corresponding ones of said fasteners on each of said two spaced rings into a hole of said vertical brace;
and sliding a drop pin mounted to each of the corresponding one of said fasteners to rest at an angle of between 30° and 60° to the vertical into a slot in their mounting pins to fasten said vertical brace to the ring by the fastener on each of said two spaced rings.

15. The method of claim 14, wherein said drop-pin of each of said fasteners is U-shaped.

16. The method of claim 14, further comprising affixing a cotter pin to an end of each said drop pin, to lock the drop pin in its slot.

17. The method of claim 14, wherein said attaching comprises bolting said two spaced rings to said ladder.
